(19) United States
(12) Patent Application Publication
(10) Pub. No.: US 2013/0163538 A1
(43) Pub. Date: Jun. 27, 2013

(54) METHOD AND APPARATUS FOR CQI (CHANNEL QUALITY INDICATOR) REPORTING AFTER THE INTRODUCTION OF A NEW CARRIER IN A WIRELESS COMMUNICATION SYSTEM

(71) Applicant: INNOVATIVE SONIC CORPORATION, Taipei City (TW)

(72) Inventor: Richard Lee-Chee Kuo, Taipei City (TW)

(73) Assignee: INNOVATIVE SONIC CORPORATION, Taipei City (TW)

(21) Appl. No.: 13/721,711

(22) Filed: Dec. 20, 2012

Related U.S. Application Data
(60) Provisional application No. 61/579,910, filed on Dec. 23, 2011.

(51) Int. Cl. H04W 72/04

(52) U.S. Cl. CPC H04W 72/04
USPC 370/329

(57) ABSTRACT

A method and apparatus are disclosed for CQI (Channel Quality Indicator) reporting after the introduction of a new carrier in a wireless communication system, wherein the UE is served by a first downlink carrier that is backward compatible and is configured with a first CQI report configuration for the first downlink carrier. The method includes (i) receiving a first radio resource control (RRC) message to configure a new carrier to the UE, wherein the new carrier is associated with the first downlink carrier for operation, (ii) receiving a second RRC message to configure a second CQI report to the UE for the first downlink carrier and the new carrier, and (iii) applying the second CQI report configuration for CQI reporting for the downlink carrier and the new carrier when the new carrier is activated or configured.

### CROSS-REFERENCE TO RELATED APPLICATIONS

The present Application claims the benefit of U.S. Provisional Patent Application Ser. No. 61/579,910 filed on Dec. 23, 2011, the entire disclosure of which is incorporated herein by reference.

### FIELD

This disclosure generally relates to wireless communication networks, and more particularly, to a method and apparatus for CQI (Channel Quality Indicator) reporting after the introduction of a new carrier in a wireless communication system.

### BACKGROUND

With the rapid rise in demand for communication of large amounts of data to and from mobile, communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for CQI (Channel Quality Indicator) reporting after the introduction of a new carrier in a wireless communication system, wherein the UE is served by a first downlink carrier that is backward compatible and is configured with a first CQI report configuration for the first downlink carrier. The method includes (i) receiving a first radio resource control (RRC) message to configure a new carrier to the UE, wherein the new carrier is associated with the first downlink carrier for operation, (ii) receiving a second RRC message to configure a second CQI report to the UE for the first downlink carrier and the new carrier, and (iii) applying the second CQI report configuration for CQI reporting for the downlink carrier and the new carrier when the new carrier is activated or configured.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known, as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a message chart according to one exemplary embodiment.

### DETAILED DESCRIPTION

The exemplary wireless communication systems and devices described below employ a wireless communication system, supporting, a broadcast service. Wireless communication systems are widely deployed to provide various types of communication such as voice, data and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. TS 36.321 V10.3.0, “E-UTRA; MAC protocol specification”; R1-100038, “On definitions of carrier types”; RP-111115, “LTE Carrier Aggregation Enhancements WID”; R2-115666, “LS on additional carrier types for CA enhancement”; Draft Report of 3GPP TSG RAN WG1 #67 v0.1.0; and TS 36.331 V10.3.0, “E-UTRA; RRC protocol specification”. The standards and documents listed above are hereby expressly incorporated herein.

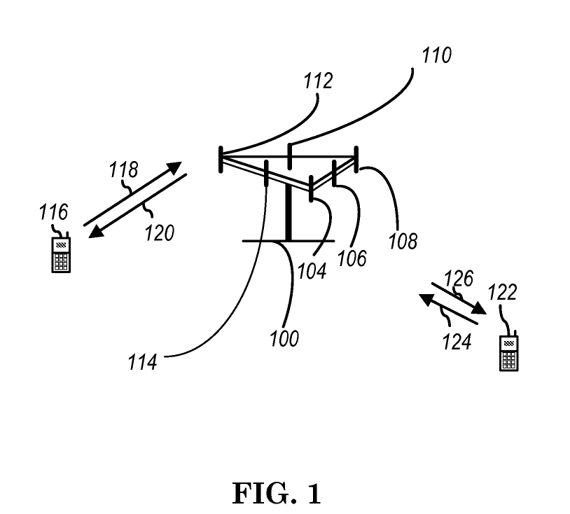

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

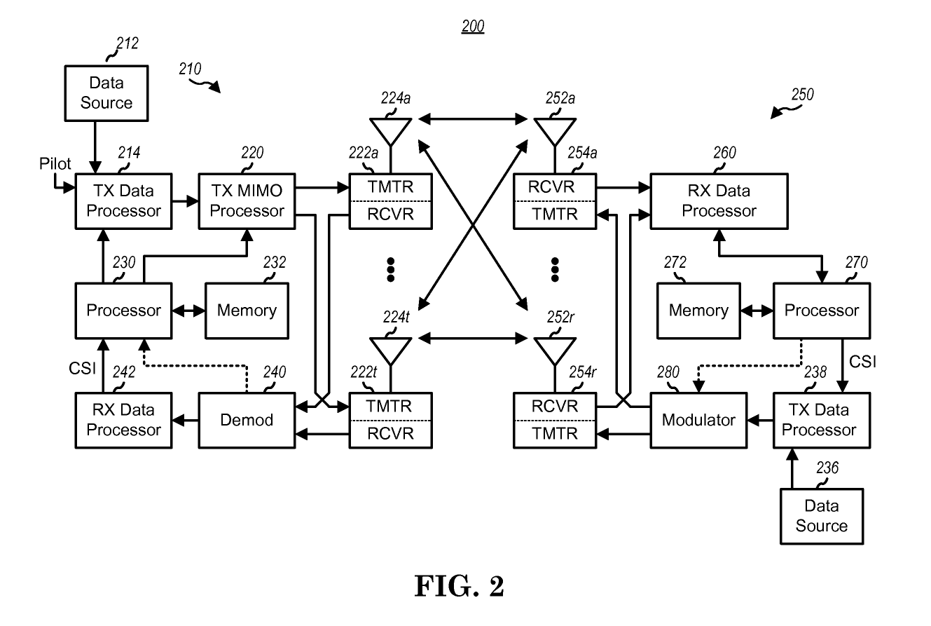

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable. for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

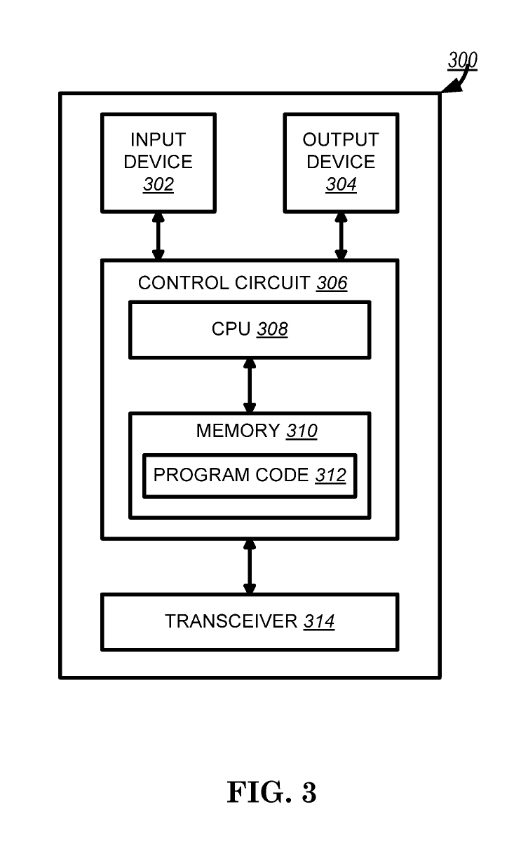

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive, signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

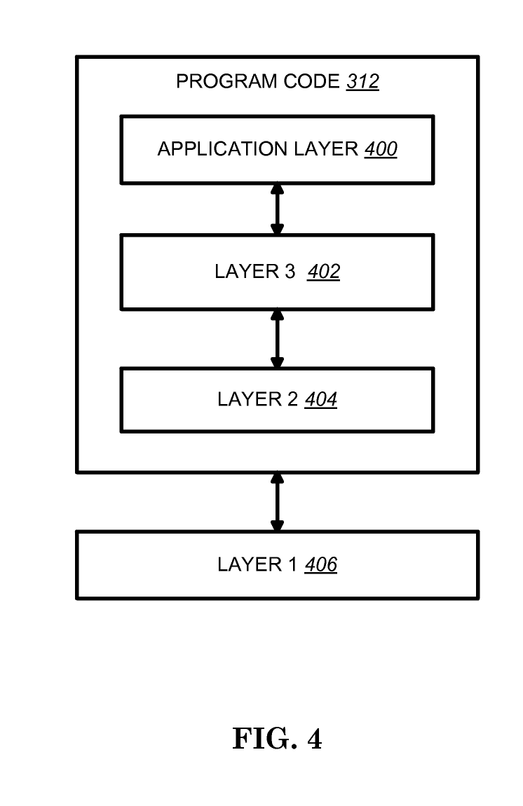

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

In general, carrier aggregation (CA) is a feature to support wider bandwidth in LTE-Advanced (LTE-A). A terminal may simultaneously receive or transmit on one or multiple component carriers depending on its capabilities. In addition to a primary serving cell (Pcell), a UE in RRC_CONNECTED mode may be configured with other secondary serving, cells (Scell).

As discussed in 3GPP TS 36.321 V10.3.0, the Peen would be considered as always activated, while an Activation/Deactivation MAC control Element (CE) could be used to activate or deactivate an Scell. An sCellDeactivationTimer corresponding to the Scell could also be used for Scell status maintenance, such as when the sCellDeactivationTimer expires, the corresponding Scell would implicitly be considered deactivated.

In Rel-10, besides backward compatible carriers, 3GPP R1-100038 defines additional carrier types as follows:

### Properties of Extension Carriers:

Supported by carrier aggregation

### Non-Backwards Compatible Carrier

Transmission bandwidth is at least from the set of existing values, {6, 15, 25, 50, 75, 100} RBs. Other transmission bandwidths may be defined by RAN4.
The sum of backward compatible component carrier and extension carrier can be more than 110 RBs.
Separate PDCCH indicates the RBs defined within the extension carrier.
It is FFS whether the linkage between backward compatible component carrier and extension carrier is per UE.
Separate HARQ process running within an extension carrier.
Backward compatible component carrier (to which the extension carrier is linked to) and the extension carrier can be configured with different transmission modes.
   Extension Carriers Configuration without CRS is FFS.
Extension carriers can be configured as contiguous or as non-contiguous to the backwards compatible component carrier they are linked to.

### Properties of Carrier Segments:

Not necessary to have carrier aggregation.
Used to enable additional transmission bandwidths beyond the set of Rel-8 values, i.e., {6, 15, 25, 50, 75, 100} RBs but no more than 110 RBs. What sets are used is defined by RAN4.
The sum of backward compatible component carrier and segment(s) shall be no more than 110 RBs. Configurations with sum of backwards compatible component carrier and segment(s) over 110 RBs are FFS.
One PDCCH indicates the RBs allocated in the sum of backward compatible carrier and segment(s).
One HARQ process for the sum of backward compatible carrier and segment(s).
Backward compatible component carrier and segment(s) use the same transmission mode.
Segments configuration without CRS is FES.
Segments are contiguous to the component carrier they are associated with.

However, discussion on additional carrier types was postponed to Rel-11 due to time limit for Rel-10. As discussed in 3GPP RP-111115, a new work item of LTE Carrier Aggregation (CA) Enhancements re-opens the discussion on additional carrier types.

3GPP R2-115666 discusses additional carrier types for CA enhancement, and includes the following conclusion and working assumptions:

### Conclusion:

From a RAN1 perspective, the main motivations identified for introducing a new carrier type for carrier aggregation are:
   Energy efficiency
      Enhanced spectral efficiency
   Improved support for het net
It is for RAN4 to determine whether there is a need for new RF bandwidths to support improved bandwidth scalability.

### Working Assumptions:

Introduce at least one new carrier type in Rel-11 (bandwidth agnostic/unknown from a RAN1 point of view), with at least reduced or eliminated legacy control signalling and/or CRS
   at least for the downlink (or for TDD, the downlink subframes on a carrier)
   associated with a backward compatible carrier
   study further:
      issues of synchronisation/tracking (including whether or not PSS/SSS are transmitted) and measurements/mobility
      resource allocation methods
      what RSs are required
For FDD a downlink carrier of the new type may be linked with a legacy uplink carrier, and for TDD a carrier may contain downlink subframes of the new type and legacy uplink subframes.

It should be noted that the scope of 3GPP R2-115666 is for CA, and that uplink enhancements are not precluded.

As discussed in the Draft Report of 3GPP TSG RAN WG1 #67 v0.1.0, further RAN1#67 agreements on additional carrier type include:

### Conclusion:

In the design of the new carrier type, support shall be provided for operation in both of the following scenarios (not necessarily equally optimized for both cases—take into account the gain that can be achieved):
   Synchronized carriers, i.e. where the legacy and additional carriers are synchronized in time and frequency to the extent that no separate synchronization processing is needed in the receiver.
   Unsynchronized carriers (i.e. where the legacy and additional carriers are not synchronized with the same degree of accuracy as for the synchronized carriers).

It should be noted that synchronization is generally considered from the perspective of the UE receiver.

Furthermore, in LTE Rel-10, CQI report configuration for an Scell is delivered to a UE when the Scell is configured to the UE, as discussed in 3GPP TS 36.331 V10.3.0. In general, as discussed in 3GPP TS 36.321 V10.3.0, the UE would start CQI reporting for the Scell when it is activated. CQI reporting for the Scell would be stopped when the Scell is deactivated. The CQI report configuration could be updated during the activated state of the Scell, and the new configuration would be applied immediately. The current CQI reporting mechanism would generally need to be adapted when an additional carrier of carrier segment is configured to a UE.

In general, when a new earner of carrier segment is configured to a UE, it would be reasonable to assume that there will be one combined CQI report for covering the sum bandwidth of both the carrier segment and the associated legacy carrier, rather than separate CQI reports for both carriers. Therefore, a new CQI report configuration should be allocated for both carriers, and it would be applied when the new carrier is activated (or configured). In addition, when the new carrier is deactivated (or de-configured), the UE should revert to the previous CQI report configuration used for the associated legacy carrier alone.

Although it may be feasible for the eNB to release CQI reporting before deactivating the new carrier to avoid using an improper configuration for CQI reporting for the associated legacy carrier alone, the release would terminate CQI reporting for the associated legacy carrier unnecessarily and would also cause more signaling overhead.

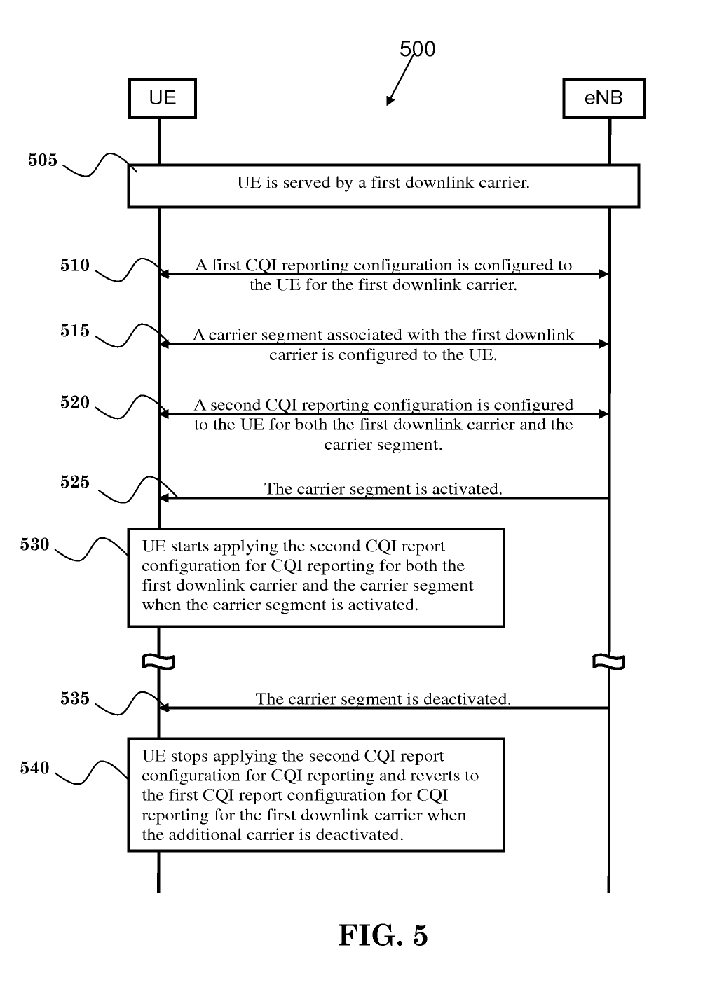

FIG. 5 illustrates an exemplary message chart 500 in accordance with one embodiment. In step 505, the UE (User Equipment) is served by a first downlink carrier. In step 510, a first CQI reporting configuration is configured to the UE for the first downlink carrier. In step 515, a carrier segment associated with the first downlink is configured to the UE. In step 520, a second CQI reporting configuration is configured to the UE for both the first downlink carrier and the carrier segment. In step 525, the carrier segment is activated. In step 530, the UE starts applying the second CQI report configuration for CQI reporting for both the first downlink carrier and the carrier segment when the carrier is activated. In step 535, the carrier segment is deactivated. In step 540, the UE stops applying the second CQI report configuration for CQI reporting, and reverts to the first CQI reporting for CQI reporting for the first downlink carrier when the new carrier is deactivated.

Referring back to FIGS. 3 and 4, the UE 300 includes a program code 312 stored in memory 310. In one embodiment, the CPU 308 could execute the program code 312 (i) to receive a first radio resource control (RRC) message configure a first CQI report configuration to the UE, (ii) to receive a second radio resource control (RRC) message to configure a second CQI report to the UE for the first downlink carrier and the new carrier, and (iii) to apply the second CQI report configuration for CQI reporting for the downlink carrier and the new carrier when the new carrier is activated or configured.

In one embodiment, the application of the second CQI report configuration for CQI reporting would stop and the first CQI report configuration would instead be applied for the downlink carrier when the new carrier is deactivated or de-configured. Furthermore, a CQI report based on the second CQI report configuration would cover a bandwidth of the first downlink carrier and the new carrier. In addition, the CQI report could be a periodic CQI report or an aperiodic CQI report

In an alternative embodiment, the new carrier and the first downlink carrier could be in the same band, and the new carrier would be contiguous to the first downlink carrier. Furthermore, the new carrier could be non-backward compatible. In addition, no synchronization channel, such as PSS (Primary Synchronization Signals) or SSS (Secondary Synchronization Signals), would be provided on the new carrier. Also, wherein the new carrier could be configured or de-configured via an RRC (Radio Resource Control) Connection Reconfiguration message. In addition, the same RRC message may also be used to configure the second CQI report configuration.

In another embodiment, one PDCCH (Physical Downlink Control Channel) could be used to indicate a downlink assignment for the new carrier and the first downlink carrier. In addition, one HARQ (Hybrid Automatic Repeat and Request) process could be used to handle a transport block (TB) associated with the downlink assignment for the new carrier and the first downlink carrier.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical block, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for CQI (Channel Quality Indicator) reporting in a user equipment (UE), wherein the UE is served by a first downlink carrier that is backward compatible and is configured with a first CQI report configuration for the first downlink carrier, comprising:
receiving a first radio resource control (RRC) message to configure a new carrier to the UE, wherein the new carrier is associated with the first downlink carrier for operation;
receiving a second RRC message to configure a second CQI report to the UE for the first downlink carrier and the new carrier; and
applying the second CQI report configuration for CQI reporting for the downlink carrier and the new carrier when the new carrier is activated or configured.

2. The method of claim 1, further comprises:
stopping the application of the second CQI report configuration for CQI reporting and applying the first CQI report configuration for the downlink earlier when the new carrier is deactivated or de-configured.

3. The method of claim 1, wherein a CQI report based on the second CQI report configuration covers a bandwidth of the first downlink carrier and the new carrier.

4. The method of claim 1, wherein the new carrier and the first downlink carrier are in the same band.

5. The method of claim 1, wherein the new carrier is contiguous to the first downlink carrier.

6. The method of claim 1, wherein one PDCCH (Physical Downlink Control Channel) is used to indicate a downlink assignment for the new carrier and the first downlink carrier.

7. The method of claim 1, wherein one HARQ (Hybrid Automatic Repeat and Request) process is used to handle a transport block (TB) associated with the downlink assignment for the new carrier and the first downlink carrier.

8. The method of claim 1, wherein the new carrier is non-backward compatible.

9. The method of claim 1, wherein the CQI report could be a periodic CQI report or an aperiodic CQI report.

10. The method of claim 1, wherein the first RRC message and the second RRC message is a RRC Connection Reconfiguration message.

11. A communication device for CQI (Channel Quality Indicator) reporting in a user equipment (UE), wherein the UE is served by a first downlink carrier that is backward compatible and is configured with a first CQI report configuration for the first downlink carrier, the communication device comprising:
a control circuit;
a processor installed in the control circuit;
a memory installed in the control circuit and operatively coupled to the processor;
wherein the processor is configured to execute a program code stored in memory to handle the reconfiguration messages by:
receiving a first radio resource control (RRC) message to configure a new carrier to the UE, wherein the new carrier is associated with the first downlink carrier for operation;
receiving a second RRC message to configure a second CQI report to the UE for the first downlink carrier and the new carrier; and
applying the second CQI report configuration for CQI reporting for the downlink carrier and the new carrier when the new carrier is activated or configured.

12. The communication device of claim 11, further comprises:
stopping the application of the second CQI report configuration for CQI reporting and applying the first CQI report configuration for the downlink carrier when the new carrier is deactivated or de-configured.

13. The communication device of claim 11, wherein a CQI report based on the second CQI report configuration covers a bandwidth of the first downlink carrier and the new carrier.

14. The communication device of claim 11, wherein the new carrier and the first downlink carrier are in the same band.

15. The communication device of claim 11, wherein the new carrier is contiguous to the first downlink carrier.

16. The communication device of claim 11, wherein one PDCCH (Physical Downlink Control Channel) is used to indicate a downlink assignment for the new carrier and the first downlink carrier.

17. The communication device of claim 11, wherein one HARQ (Hybrid Automatic Repeat and Request) process is used to handle a transport block (TB) associated with the downlink assignment for the new carrier and the first downlink carrier.

18. The communication device of claim 11, wherein the new carrier is non-backward compatible.

19. The communication device of claim 11, wherein the CQI report could be a periodic CQI report or an aperiodic CQI report.

20. The communication device of claim 11, wherein the first RRC message and the second RRC message is a RRC Connection Reconfiguration message.
